(19) United States
(12) Patent Application Publication
(10) Pub. No.: US 2013/0298462 A1
(43) Pub. Date: Nov. 14, 2013

(54) Modular plant growing system for food production and decoration, and methodology for use.

(71) Applicant: Sean Thomas Moran, Coos Bay, OR (US)

(72) Inventor: Sean Thomas Moran, Coos Bay, OR (US)

(21) Appl. No.: 13/470,355

(22) Filed: May 14, 2012

(51) Int. Cl. A01G 9/02

(52) U.S. Cl. 47/66.7; 47/67

(57) ABSTRACT

The present invention comprises a modular horticultural growing system, creating a multitude of benefits through the utilization vertical growing capability and methodology. These benefits include increased growing densities, maximization of growing efficiencies, minimization of water usage, retention of nutrients, reduction of nutrient discharge into surface and ground water, increased growing capacity within existing capital infrastructure and space, reduction of energy and material inputs, cooling and beautification of structures and living spaces, increased local food production, synergistic effects throughout entire product, manufacturing, and production value chain, and many other benefits. The present invention allows individuals, especially those living in impoverished or densely populated urban areas, to grow a greater fraction of their food requirements. The preferred embodiment of is comprised of a hook, hanger, growing pot, hook trough and hook connector allowing for connection of additional growing units or other items to the bottom of each unit.

### BACKGROUND OF THE INVENTION

Modern agricultural practices constitute one of the major pillars that have enabled human society to rise above its tumultuous past. Although engineering, civil infrastructure, advances in materials and medicine, the discovery and harnessing of fossil fuels, and other advancements hold similar stature in this picture of success for human society, the development of stable and nutritious food supplies has proven to be a necessary condition for this rise. These advancements enabled our species to gather together and to live in larger groups, concentrating human knowledge, and accelerating the advancement of human society. Human society has breached the carrying capacity of our planet, and now must adopt a more sustainable view of its activities, and how they affect the natural environment. The current field of the present invention is focused on agriculture, horticulture, hydroculture, hydroponics, and efficient and sustainable plant growing practices that will help to ensure our continued success.

Demand for agricultural products, on a global scale, has been met through generally unsustainable agricultural practices, subsidized by inexpensive energy. It is well supported that global energy demand and increased competition for resources will result in increased energy prices and other systemic costs. As these pressures force human society to convert common practices toward more sustainable practices, individuals will be required to seek less expensive alternative means to procure nutritious foods. This argument proves that individuals can make a difference, since overall impacts are created by the summation of individual actions as a whole. Individuals' demand for products and practices that meet these inevitable requirements will drive this new industry. Individuals, economies, industries, society, and the environment can significantly benefit through the utilization of the present invention. Individuals can grow a greater fraction of their nutritional needs. Local and regional growers can produce more products locally, with a decreased energy footprint using inexpensive and reusable equipment, and existing infrastructure. In practice, the present invention improves living spaces through beautification and cooling, decreased reflectivity and increased absorption of heat and sunlight. Only slight modifications to existing systems, and manufacturing and growing processes to realize the full benefit of the current invention.

As global agricultural industries make the transition to more sustainable practices, the demand for locally or individually grown products, and the supporting products and equipment industries will explode. These markets will have their own challenges and requirements. The present invention is designed to help meet these needs.

The current global markets for hanging plants are well understood, and well developed. This includes the entire value chain, including raw materials sourcing, manufacturing, distribution, commercial growing, retail and the end consumers. It is a primary goal of the present invention to adapt the practices, and value chains, of the hanging plant industry toward the global production of hanging agricultural products. This will particularly impact those living in urban, suburban, and especially impoverished, densely populated demographics. These groups will be the most severely impacted by the changing global agricultural environment. This approach is also established in order to minimize the required behavioral changes of individuals, and of all related industries. Large commercial growers are the primary source of hanging plants. It is highly feasible, through the utilization of the present invention, that these commercial growers will find a demand for hanging food gardens. Consumers of these systems will grow these gardens in a very similar manner as hanging plant gardens. These consumers will be able to visit their local garden center, and purchase ready-to-hang hanging food gardens by specifically selecting each individual product that meets their food needs. These gardens are modular and adaptable, where newer and older food plants and be grows together to offset yields, and extend yield windows. Commercial growers can improve facility growing capacity by between 200-300 percent, deferring expensive capital improvements, and therefore will be able to meet the new demand for these hanging garden products immediately. Retailers can offer more products while utilizing less retail shelf space. The improvements to overall value chain efficiency will help to reduce costs, resulting in more affordable hanging food growing systems. Finally, the present invention will function to enhance and grow the existing hanging plant market as well. Consumers will be able to easily create vivid and beautiful flowering plant displays that are layered or chained together. The present invention is inexpensive to manufacture, distribute, utilize, and can be reused repeatedly. Global infrastructure, manufacturing capacity, raw materials, distribution channels, growing practices, and the entire value chain for this industry currently exists to support the requirements of this potentially large area for global growth. Therefore global markets are well suited to support the propagation, and full exploitation, of this new technology. Global societies, economies, individuals, the natural environment, and all levels of the value chain for this industry can benefit from the ingenuity of the present invention.

The current state of the art for growing has focused on more efficient production methods, and improved chemicals and equipment for larger scale growing. A search of patents, non-patent literature, and prior art shows that little innovation has been developed to help individuals' access, or has enabled them to grow a greater fraction of their food requirements. These industry markets have become saturated, and focused mainly on incremental innovations for present uses. New innovation is needed and highly valued by this industry, which will provide an excellent opportunity for the present invention.

In an effort to help solve some of the most challenging problems of our time, a primary aim of this invention is to provide a means to maximize agricultural, horticultural and plant mass yields, while helping to ensure that a greater fraction of food requirements can be produced locally. A specific goal of this invention is to allow the enhanced practice of individual food production, especially within more densely populated urban areas.

### OBJECTIVES OF THE INVENTION

The primary objectives of the present modular plant growing system are to:

Provide a modular horticultural growing system, which allows for improved growing, supply chain, distribution, and operational efficiencies, while also enhancing operational flexibilities. These efficiencies result in significantly increased growing capacity with minimal modification or investments to existing capital infrastructure, and reduces the overall required costs and resources for the entire product lifecycle and value chain;

Provide means to significantly enhance current food growing density, through utilization of this novel vertical growing invention and its associated methodology, which allows greater individual access to less expensive, healthy food products;

Provide means to meaningfully enhance the ability of dense urban populations to access and grow healthy, less costly food;

Provide a simple, effective, easy to use innovation, that provides the means for individuals to grow a greater fraction of their own food products;

Provide a means for the beautification and cooling of living spaces;

Provide a means to minimize the energy inputs into a growing system;

Provide a means to minimize the average distance inputs must travel to reach a growing system, which enhances local and regional growing support, local economies and reliance on outside resources.

Provide a means to minimize water and nutrient loss, while minimizing water pollution during the growing process, and impacts to the overall natural environment;

Meet these objectives within the current confines of the state-of-the-art throughout this value chain, so as to maximize the potential for quick adoption and technology propagation, thereby gaining acceptance by industry, and other stakeholders.

Minimize barriers to entry for present invention through minimization of required behavioral changes by all prospective users from each level of the value chain.

Additional objectives will become apparent for the present invention upon review of the included figures and detailed description.

### BRIEF SUMMARY OF THE INVENTION

The primary object of the present invention is to create a novel and innovative modular plant growing system that will maximize the efficiencies of growing, while creating a multitude of additional benefits to society and the planet as a whole. The method for use of the growing system is also developed and claimed as novel.

The present plant growing system is comprised of a hook at the upper termination of a hanger. The hanger then terminates at the upper end of a plant growing pot. The bottom surface of the growing pot includes a hook trough, and an associated hook connector, for connecting additional growing pots, or other useful, or decorative accessories in a vertically suspended series. A multitude of the present invention can be suspended in multitudes of configurations, or orders. The present invention allows the attachment of additional items or accessories. The hook is designed to terminate to any conventional hanging planter connector that is capable of accommodating it, such as hooks, horizontal bars, hanging planter attachments, or other hanging locations. This may include hanging plant growing track systems commonly found in commercial hanging plant growing facilities. The hook trough and hook connector are designed to create a strong, secure and reliable means for temporary connection of vertically adjacent items. The hook cannot become disconnected without the utilization of the claimed methodology, which is comprised of a smooth, ergonomic and simple disengagement motion between the hook connector and the hook of the adjacent suspended item.

The present invention can incorporate the latest state-of-the-art for growing, including hydroponic planter pot inserts. These inserts can be used to enhance growing and nutrient influx to the growing plant, while ensuring that plant roots are not submerged in water. This invention does not claim these technologies as part of the novel element of innovation, but rather than the state of the art can easily be accommodated and incorporated into the present modular growing system. The invention may, or may not, include various inserts, similar to the hydroponic insert discussed above, but additional novel inserts are included in this novel invention. Growers often wish to actively drain excess water from the bottom of their growing pots. In this case, either no insert is required, or a basic insert can cover the hook trough, directly above the hook connector, to ensure that soil and roots do not intrude the hook connector space. Another type of insert can create a watertight seal over the hook trough, which will allow no water or root intrusion into the hook trough space. An additional type of insert can incorporate specifically located drain holes that will control the drainage location of surplus water, and direct it to a specific desired drain hole location in the bottom of the pot. This is very similar to the current state of the art, but has been adapted to this novel technology as shown in the figures, and as discussed in the detailed description of the present invention. Finally, the hydroponic insert itself may have an integrated cover as shown in the figures. This novel approach incorporates the functionality of the current hydroponic inserts, while enhancing the capabilities of the invention. This also creates additional efficiencies through the manufacturing process. In this case, the hook trough cover is integrated into a hydroponic insert, which intentionally aligns the elements of the overall system to the desired performance characteristics, such as drainage, or water-tightness preferences.

The present invention expands the capabilities and sizes of current related markets. Hanging planter pots are typically of one form factor, which is that of a round cross-sectional form. There are several advantages of this form, including a normalization of radial forces that ensure the loading delivered to the system does not deform the pot itself. The present invention now allows other types of growing pot form factors to be accommodated. This is shown in the figures by demonstrating that polyhedral, or rectangular cross-sectional growing pots can be accommodated as well. In addition, these rectangular pots will prove additional benefits over the current state of the art. Rectangular pots can provide a larger growing area and nutrient volume for growing plants. This will allow for greater food yields, or more spectacular decorative hanging plant demonstrations. This type of pot could be suspended individually, or could be configured to add additional growing pots, in series, as shown in the futures. This is accomplished through the integration of two hooks, two hangers, two hook troughs, and two hook connectors at opposing ends of the rectangular pot. This can include any of the insert configurations discussed above for similar functionality and desired performance. Since the basic elements of this modular system are the same, additionally suspended items need not be only rectangular pots with a similar configuration. Traditional hanging growing pots, or other accessories can be suspended from these locations, including any item requiring a connection point. This could include nearly any reasonable accessory such as decorative garden products, watering facilities (drip irrigation), birdhouses, vine training wire (or rope), wind chimes, or any other type of accessory.

The global benefits enabled by this innovation are significant. As mentioned above, the use of rectangular pots allows for greater growing surface area and nutrient volume, which can lead to improved food product yield, as well as for impressive decorative plants and flowers, with cascading foliage, or other impressive features. Creative grower will be very excited to practice this new capability. Additionally, the cooling of living spaces and structures will be enhanced through shading and direct heat absorption, and reduced reflectivity. To validate this, consider a 12-inch diameter round planter pot. It will have approximately 0.7 square feet of surface area for growing, and approximately 0.5 cubic feet of nutrient soil volume. A rectangular pot 24-inches long and 8-inches would have approximately 1.3 square feet of surface area for growing, and approximately 1.0 cubic feet of nutrient soil volume. This results in an 85% increase in growing surface area, and a 100% increase in nutrient soil volume. This capability is a significant innovation in this field. The most impressive results can be seen when comparing a single hanging growing pot, to a vertical sequence of three rectangular pots. The growing surface area, and nutrient soil volume are approximately 550%, and 600%, respectively, as compared to a single hanging pot system. Let it be noted that the anchoring location must be adequately designed to ensure that it can support the loading of the total loads for all pots. The manufacturing and design environment, including the load path through the system is discussed in more detail below. Most growing, distribution, and retail organizations already have specific supporting infrastructure capable of supporting these two-point rectangular pot loads. Often times, this is simply comprised of a horizontal bar. Many establishments support long lines of growing hanging product on these bars, which would be more than adequate to support these rectangular pot systems. End consumers can either construct their own horizontal bars for these rectangular hanging growing pots, or aftermarket manufacturers may offer ready to install products to support the product line.

The design and manufacturing environment of this industry is well understood. Let it be noted that each new vertical growing system pot will require specific structural and performance enhancing elements required to accommodate the additional loadings caused by the adjacently suspended items. This requirement is mitigated by the fact that planter pot manufacturers create new production tooling often, and for each newly introduced product or design. Integration of the present invention into existing product lines would be very simple, as it would be integrated into the latest production tooling. In addition, the present invention could be integrated into any new hanging planter system without affecting the mode by which existing users utilize existing designs, or products.

The load path for a hanging series of two pots begins at the bottom-most pot (or item). For this discussion, it is assumed that the pots have been structurally reinforced through well-understood design and manufacturing methods (ribs, gussets, baffle walls, or other structurally necessary enhancements). The loading due to the plant, soil, water content, and pot materials in the bottom pot is transmitted to the hull of the bottom pot through multi-modal load sharing (shear, tension and compression). The hull of the pot transmits the loads to the hanger, which then transmits the entire load of the lower growing pot to the hook connector of the upper hanging pot. The hook connector transmits the loads to the hook trough, then to the pot hull of the upper pot. This is a critical element of the design of this growing system. The upper pot also must transmit the loading of its own contents to its hull. Therefore, the hull of the upper pot must be capable of supporting greater than twice the loading as the lower pot hull. The total loads are then transmitted in a similar manner to the first pot (through the hull, to the hanger, to the hook). The total load of the entire suspended planter system will be supported by the upper hanger, hook, and anchoring location. This is another critical element of the system design. The anchoring location for the system must be strong. Let it be noted that if there were three pots in a vertical series, the top pot must be capable of supporting more than three times the loading of the lower pot.

The present invention creates significant benefits and efficiencies to the entire value chain for the entire product lifecycle, including all stakeholders. These benefits also create new, or expanded, product markets with enhanced benefits to the environment. The following discussion will provide an overview for each of the types of benefits.

Manufacturers of hanging planter growing products operate in highly competitive markets that are critically driven by incremental innovation and commodity prices. Demanding customers have many choices. Manufacturers are capable and willing to develop custom products for important customers. For example, a commercial grower, growing a specific species of plant will require an optimal spacing between adjacent hanger growing units. This can easily be accomplished by providing hangers with various lengths, which will easily change the distance between adjacent hanging growing units. The competitive environment if fierce, with global implications, low margins and high volume. These manufacturers understand the resource-intensive nature of the industry, and come under continual scrutiny from retailers, distributors, and end users to account for diverse concerns. These groups often work in environmentally conscientious fields, and themselves answer to intense pressures from their customers to adopt more sustainable practices. These manufacturers expend significant resources for research and development toward innovation with specific goals to reduce energy consumption and their environmental footprint, and provide environmentally friendly product solutions for the industry. This environment has led to competition in adjacent markets and has forced many manufacturers to seek horizontal and vertical integration strategies. The present invention will provide a very clear message from these manufacturers to their customers; that they continue to seek innovative ways to increase efficiency and to reduce their overall carbon, and environmental footprint. These manufacturers understand their constituents believe technology has a critical role to play in helping to solve our systemic problems toward a sustainable future. Although the present invention does require marginal increases in overall raw material volume per each unit, due to required structural considerations, the net benefits throughout the industry will far outweigh this marginal cost. The costs for these manufacturers will slightly increase, yet the innovation, and its benefits will help to ensure market success. These manufacturers will be able to charge a premium for this innovative technology to growers. The efficiencies gained by commercial growers will result in decreased costs to retailers, and therefore consumers will pay less for these new products than they do for currently available inferior products.

Distributors of hanging pot and garden systems also work in highly competitive markets, which requires very strong relationships with their customers. Customers of these products can be retailers, or commercial growers. Often these customers are major retailers and major growers. These customers are very demanding for specific functionality, performance, cost and low impacts to the environment. These significant pressures are passed from these distributors to the manufacturers. Manufacturers seek to meet these impressive demands through the collaboration between distribution and customers.

Commercial growers are a critical point of the value chain. Large commercial growers often have significant capital investments in their growing facilities and work with relatively small margins. Efficiencies gained through product innovation can result in deferred costly capital investments. Growers can also accommodate species-specific hanging growing unit spacing requirements through customized products from the manufacturer, including longer, or shorter, hangers. This is easily accomplished. Additional growing capacity is a very expensive prospect to consider. Large commercial growers begin their nursery stock in large growing facilities and greenhouses. These growing facilities often have complex and costly, elevated automated track systems for growing hanging plants. These track systems often have automated watering stations, and movements. These systems also help to ensure that each plant receives an excellent distribution of light, and therefore can grow uniformly, resulting in excellent product quality and high value. As plants are maturing on the track system, new plants are becoming ready for the track system. This cycle is one element that has defined the production capacity of the growing facility. The present invention will provide a clear means to capture new customers by showing that the drive to innovate has resulted in significant progress.

Commercial growers using the present invention can grow more efficiently, reducing costs, and increasing margins. Some of these savings can be passed on to retailers, which will help to ensure high volume and excellent revenue growth. Functionally, these growers will be able to capture additional plant nursery sites and intermediate growing sites. This is not accomplished through expensive acquisitions, or costly capital infrastructure investments. This space currently exists in existing growing facilities, directly below the mature growing plants by using the present invention to use unutilized air space. Smaller plants require less light, so the most mature plants will grow in the topmost position. Less developed plants can be potted in commercial pots, and connected directly to the currently hanging plants. This can be done in multiple layers. This saves on labor and time, and constitutes additional operational flexibilities. As mature plants become commercially viable and ready for retail sale, the vertical growing layers are quickly deconstructed, and reconstructed at a handling station, which is the current state-of-the-art. For example, with three-layered system, the lowest pot is removed, then the middle pot is removed, then the highest pot is removed. The highest, and most mature, pot it conveyed toward the next milestone of the value chain, toward retail sale. The previous middle pot is now promoted to the highest location, to become the next mature product. The previous lowest pot is now promoted to the middle location, and a new immature pot is promoted from the nursery to the lowest hanging location. A nursery location is now freed up for a new seedling pot. Another way to describe this growing process is first-in-first-out, where immature product passes through the growing process, then leaves as mature product.

In consideration of the above discussion, it can be seen that growers and distributors can gain significant production capacity within existing facilities without expensive capital infrastructure investments. Additional benefits include a new type of buffer to the value chain, and inventory process for hanging vertical products. Water usage and nutrient loss are minimized, while water pollution during the growing process is also significantly mitigated. Drip irrigation systems have become a staple of the growing industry. These irrigation systems allow growers to minimize the amount of water used, while minimizing nutrient losses (resulting from nutrient rich drainage). Drainage for growing plants is very important to ensure proper growth and plant health. Many plant species require that their root systems not be submersed in water. The result is that water may run through the plant soil and drain out, no matter how well managed the drip irrigation systems are maintained and operated. This water can transport nutrients to the drainage systems, which would be much more efficiently utilized if they were to be retained in the soil of the growing plants. This water can ultimately lead to contamination of surface and ground water. Many growers work to mitigate this through the use of water recycling systems, or treatment systems. The present invention provides a solution to this problem. Growing plants on the lower layers can capture, and utilize, the nutrient rich drainage water, while creating a redundant system for drainage water capture. Immature hanging plants on lower layers require less water. Since draining water from higher-level plants retain the majority of irrigation water, the lower level plants are in the ideal operational location to efficiently utilize nutrient rich drainage water. If managed properly, very little water will escape the dripping irrigation system. This can minimize loading on treatment systems, increase efficiencies, reduce costs, and maximize nutrient delivery to growing products. The risks for potential contamination of ground and surface water can be decreased significantly as well.

Retailers within this industry are clearly defined, but exist under various business models, where the lines between growers and retailers are often blurred. Major retailers often purchase products and materials from major manufacturers, and major commercial growers. Smaller retailers are often growers and retailers, where growing and retail space are co-mingled, or the retail space is close to adjacent growing space.

Major retailers are not focused on commercial growing, but rather have large garden centers that function as temporary nurseries for various products. This can include products that allow consumers to purchase materials for their own growing efforts, such as pots, soil, seeds, seedlings, vegetable plants or flowers, and other products. These retailers also sell fully mature flowers and plants for gardeners to develop their own gardens and flower displays with less effort. Some of these products come in read-to-hang flowers and plants that come directly from commercial growers. Many of these major retailers have significant infrastructure to support hanging plants, with strongly supported horizontal bar systems, which are well suited for vertically hanging chains of products developed in this disclosure. As shown in the figures, these systems can be used to display a “wall” of hanging plants, which can include both rectangular and circular pot systems. When the customer selects a particular product displayed in a vertical chain, the garden center employee simply deconstructs each layer to free the selected product, and then reconstructs the layer. This is similar to the method that would be used by commercial growers themselves during the growing process. The present invention allows major retailers to maximize valuable retail space, while creating beautiful “walls” of hanging plant products.

Major retailers could offer an entire new line of hanging food garden products designed for immediate consumer use. The present invention makes it practical for retailers to sell ready-to-hang food gardens to consumers. Commercial growers can grow food producing plants directly in hanging growing pots, in a similar manner to which they grow hanging flower growing pots. The present invention allows commercial growers excess capacity to meet the demands of this new industry. Major retailers could display and sell a large variety of ready-to-hang food garden products, where consumers simply select their desired products and hang them at home to immediately create a complete hanging garden. Retailers can also sell the present invention and allow customers to purchase the raw materials to create their own hanging gardens. Retailers currently offer growing pots and related materials, for this purpose, so no behavioral changes are required by the consumer.

Major retailers can purchase products utilizing the present invention with no improvements to capital infrastructure. They simply adapt their displays. Although there are slight increases in material used to manufacture the invention, for structural supporting elements, the savings gained through commercial growing more than justify the additional materials costs. The net effect will result in reduced costs for retail products to the consumer, with excellent new functionality gains to consumers. Additional cost savings are realized through much more efficient use of valuable retail space. Major retailers will be able to present hanging plant products in less space, with more beautiful presentations, which frees up additional retail space for other products, or additional hanging plant products. Ultimately, major retailers will realize benefits on many fronts due to the present invention.

As discussed above, as global energy prices rise, industries will be forced to change the way they operate. A driving force behind this is the end cost to the consumer. Individuals in the future will have great cost, and health, incentives to grow a larger fraction of their own food requirements. This can currently be seen in the Locavore movement, which seeks to minimize the mean energy required by utilizing locally sourced inputs and products to a food system. It is becoming more popular for individuals to grow a fraction of their own food in pot-based systems. This is especially the case in urban areas, or suburban neighborhoods, where garden space is limited. At the present time, some perceive this movement as a novelty, but this truly represents a greater global movement that will prove to have a high value to individuals, society and the global environment.

The present invention represents a new global opportunity for economic growth, while adding significant contributions toward the solutions of these problems. The present invention provides a practical means by which major retailers, and commercial growers, can introduce new vertically chained hanging growing food, and flowering plant, product gardens. This can be realistically envisioned by surveying the hanging flower plant market and industry. Major retailers can now sell “ready-to-hang” vegetable gardens for any end users. The consumer benefits of this are discussed below, but the benefits to commercial growers, retailers, and consumers are very clear. The innovation could be well received by all stakeholders for its significant benefits.

The needs of consumers drive the global economic environment, where resources are increasingly scarce, and energy costs are projected to rise as global populations grow. As discussed above, the pressures on individuals to make more prudent, cost effective, and healthy choices concerning their food are increasing. The present invention essentially creates a new global market, where consumers can easily, quickly, and cost-effectively grow a greater fraction of their total food requirements. It also expands the existing hanging plant markets. The present invention allows individual consumers to utilize the commercial growing methodologies for hanging plants for their own food production. Considering these facts, commercial growers, retailers, and consumers functionally become partners in the growing, production and consumption of food for society. “Ready-to-hang” vertically chained gardens will allow individuals to quickly select which food products they wish to grow, and easily grow them at home with minimal effort. This is especially useful in urban and suburban environments, where garden space is limited, or a garden is impractical. Conventional garden growing will also be enhanced. These individuals can expand their gardens by hanging growing food in unutilized locations. For example, growers will be able to build a simple rectangular frame behind their current garden, and hang arrays of growing food. These products can be harvested in modular fashion. For example, an array of hanging raspberry plants can be harvested one plant at a time. The specific pot can be disconnected from the array, and brought inside, or suspended closer to the living area growing space for easy harvesting. The operational growing flexibilities enabled by the present invention are extensive in this regard. Growing food becomes significantly more convenient and cost effective for individuals. It will become increasingly more important or individuals to know the sources of their food. Commercial farming practices will also come under increased scrutiny, so it is a significant benefit that individuals can take greater control of their health and dietary needs through the utilization of the present invention.

Individuals and consumers will realize many additional benefits from the utilization of the present invention. These benefits include the beautification and cooling of living spaces and minimal space requirements. This system can be utilized indoors or outdoors, so consumers will be able to develop beautiful and creative plant and vegetable displays. The modular capability of the present invention will provide excellent flexibility and mobility of hanger planter displays. Hanging planters are often suspended near internal corners to fill the space with plants. The present invention will allow consumers to suspend vertical-chains of plants from ceiling to floor, and to cascade plants over lower plants to create dense and beautiful columns of plant life. Cascading plant and vegetable gardens can be grown from nearly any overhead location with proper support. So places could be utilized for the present invention that normally would not be practical or useful. The modular nature of the present invention allows the user to harvest one pot at a time and replace it with another at any time. This allows the user to treat a garden or planter as modular in all respects, and to spread out their growing season to ensure an excellent supply of food products throughout the growing season. Modular harvesting of growing foods creates other significant benefit as well. Growers can select any particular hanging pot to harvest at any time, and rearrange the configuration at any time to meet specific growing, or logistical needs. Greenhouse space can also be utilized more efficiently, allowing greater density and larger food yields. Another factor increasing growing density is the basic ability to vary the length of the hanger. Its length can be varied depending upon the plant species and the desired growing density. Consumers will realize efficiency gains comparable to commercial growers, as is discussed in details above. These gains include reduced water usage and the minimization of nutrient loss due to drainage of nutrient rich water. Consumers can now minimize the average distance of inputs, and overall energy usage to grow their own products. Users that would not normally be able to grow a food garden due to constraints to growing space, or other constraints, can now have a garden. The mere fact that they have a garden allows growers to capitalize on the benefits of composting. Composting utilized waste products to generate nutrient rich input to the gardening process, and minimize the needs for other inputs into their growing systems. Many compact composting products currently exist on the market, which allows users of the present invention to capitalize on this benefit.

Another primary objective of the present invention is to maximize the potential for technology adoption by minimizing required changes to stakeholder habits or behaviors. Though the utilization of existing manufacturing technologies, growing practices, transport, and all other elements of the value chain, the present invention accomplished this goal. Products incorporating the present invention will minimally affect stakeholders at all levels of the value chain. Product embodiments incorporating the present invention will essentially be invisible to users using these products in the conventional manner. Therefore, there is little reason not to incorporate the present invention into current and future products, especially considering that manufacturers create new production tooling often.

The present invention creates a modular growing system with means for universal connection of vertically adjacent items, not only additional modular growing units. An entire industry of related connection accessories, products and functionality could be connected to the universal connectors of the present invention. These connectors can be utilized to connect irrigations systems, decorative garden products, such as bird houses, wind chimes, bird feeders, or any other practical product or form desired. This could also include the connection of wire, or string that could be used to train plant vines in any direction from the growing pot itself. These strings could be connected to nearly any surface with nails, or other fastener, or could be staked into earth. Therefore, vines, such as grapes, tomatoes, or flowering vines can be trained toward any location from the bottom of each modular pot in the system. Virtually any practical connector can be used to attach other items, such as s-hooks, clips, rope, or wire, as shown in the figures. The connector is designed for these extraordinary purposes.

Human society has learned that the planet can no longer be considered a reservoir to its activities. It is now generally accepted that human society will need to adapt to these realities. It is a primary objective of the present invention to create new efficiencies, capabilities, and synergies with the entire value chain of related fields and industries to minimize impacts to the natural environment. Many of the benefits to the environment are briefly discussed above, yet the benefits due to the present invention cannot be understated. The present invention creates new efficiencies and enhancements at each level of the value chain, which result in reduced impact to the environment. These benefits include the minimization of water usage, the retention of nutrients, the reduction of nutrient discharge that results in contamination of surface and ground water, increased growing capacity within existing infrastructure, reduction of energy and material inputs to the system, cooling and reduction of reflectivity of structures, reduction of average distance for input transport, increased local food production, synergistic effects throughout entire product, manufacturing, and production value chain, and other environmental benefits as discussed throughout this disclosure.

Manufacturing materials and processes for the present invention are well developed. Relatively advanced design and manufacturing technologies are utilized in the development of hanging planter pots. State of the art three-dimensional computer aided design and analysis software packages are utilized to create unique, attractive, functional, and strong designs. This process is used to ensure performance and that the product can be easily manufactured with the current state of the art for manufacturing processes. An additional goal is to minimize the amount of raw material that must be used to manufacture each pot, since related competitive global markets are driven by raw materials, energy, and commodity prices. Existing products are manufactured using well understood methods, including extrusion, molding, injection molding, blow molding, forging, thermoforming, stamping, multi-process manufacturing, or other typical plastic manufacturing methods. Growing pots are often manufactured in multiple separate parts, and then assembled together. This is usually required to ensure that the most cost-effective methods are utilized for the finish product, which usually results from plastic injection molding. This method uses raw plastic product, usually in the form of chips or pellets, which are melted and pumped, or pressed into a pre-manufactured mold. Once the molded material is cooled, the mold is opened, releasing the product. The final parts are assembled and the product is packaged for shipment. The present invention may use any of these materials or processes to create unique system, comprising the novel and useful elements of the disclosed invention.

The current state-of-the-art has been discussed in this disclosure, including currently available products on the market. Many products have been on the market in this field for decades with relatively little change in form or function. Other products are relatively new, including the Topsy Turvy, which grows tomato plants upside down. This helps the growing process of tomatoes and makes the process of growing simpler by removing the requirement for staking and training of vines. It also minimizes potential kinking of vines that can damage the plant. The present invention incorporates elements for training vines, including training of vines along adjacently suspended hanging planter units. Vines can be trained across the top of lower pots resulting is improved vine plant growing performance. Also, as is discussed throughout this disclosure, strings or wire can be connected to the bottom of each modular growing unit, by various methods, and extended to nearly any surface for the purpose of training vines of plants. Many products on the market hope to mimic a “tree” of hanging planters. These are often very expensive, being made of strong metal structures that are resource intensive throughout the entire value chain. Some of these products can cost $60 or more, only providing basic supporting infrastructure for hanging multiple hanging planters in limited space. The present invention makes these products obsolete, other than when the consumer chooses these products as a preference. Since the present invention incorporates the capability to hang multiple hanging planters together in arrays, the cost is negligible as compared to these products. Various planter products exist on the market that seek toward vertical or modular growing capability. Vertically suspended planter pots have been on the market for decades. These typically are accomplished through relatively expensive products using chain or heavy rope to cascade multiple pots together. These products are not modular, as they are typically fixed together in the prefabricated configuration. Other products include stackable growing pots that include designs that offset specifically oriented growing openings. These products typically require a stable and level location on the ground, and often require staking for support. These products are not truly modular, since once the growing plants are mature, they cannot be easily taken apart. These products also force plants to compete for sun exposure, and therefore the productivity of plants can be negatively affected. Other products further include arrays of permanently fixated infrastructure, including grids that support existing pots, or many other configuration requiring significant capital expense, and limited modular capability. Many patents exist for related products and industries. The majority of recent prior art have focused on watering systems, hydroponic elements, or other related incremental improvements over existing products. Many of the products mentioned are available from many retailers, including online grower supply companies, and major retailers such as Target, Kroger, Home Depot, WalMart, and many others. These businesses thrive upon innovative new products, which makes this industry well prepared to accommodate the present invention. The present invention is superior to all of the product mentioned above, and solves all of the related problems by integrating the greatest benefits of each of the technologies. The present invention is truly modular, maximized growing densities, without forcing plants to compete for nutrients or sunlight. The innovation is very inexpensive and requires no special skills or changes to behavior or practices at each level of the value chain.

The present modular growing system is different from any other growing system ever created. Current growing systems cannot realize the benefits discussed in this disclosure. These benefits are clearly defined, and the barriers to acceptance of this technology are low. Therefore, the present invention is far superior to existing technologies, and helps to solve the problems presented in this disclosure.

The functions, claims and relevance of the present invention to the current state-of-the-art is defined in greater detail in the following detailed description of the preferred embodiments in conjunction with the provided drawings.

### BRIEF DESCRIPTION OF THE SEVERAL VIEWS OF THE DRAWING

FIG. 1 is an exploded, cut-away, front perspective view of one embodiment of the present modular plant growing system, specifically illustrating a basic means for connection of one modular unit to another modular unit, where the hook on the lower unit passes through the open hook trough of the upper unit, and rests upon the hook connector of the upper unit.

FIG. 2 is an exploded, cut-away, front perspective view of one embodiment of the present modular plant growing system, specifically illustrating a basic means for connection of one modular unit to another modular unit, where the hook on the lower unit passes through the open hook trough of the upper unit, and rests upon the hook connector of the upper unit.

FIG. 3 is an exploded, cut-away, front perspective view of one embodiment of the present modular plant growing system, specifically illustrating a basic means for connection of one modular unit to another modular unit, where the hook on the lower unit passes through the open hook trough of the upper unit, and rests upon the hook connector of the upper unit.

FIG. 4 is an exploded, cut-away, front perspective view of one embodiment of the present modular plant growing system, specifically illustrating a basic means for connection of one modular unit to another modular unit, where the hook on the lower unit passes through the open hook trough of the upper unit, and rests upon the hook connector of the upper unit.

FIG. 5 is a zoomed-in, exploded, cut-away, front perspective view of one embodiment of the present modular plant growing system, specifically illustrating a basic means for connection of one modular unit to another modular unit, where the hook on the lower unit passes through the open hook trough of the upper unit, and rests upon the hook connector of the upper unit.

FIG. 6 is a zoomed-in, exploded, cut-away, front perspective view of one embodiment of the present modular plant growing system, specifically illustrating a basic means for connection of one modular unit to another modular unit, where the hook on the lower unit passes through the open hook trough of the upper unit, and rests upon the hook connector of the upper unit.

FIG. 7 is a zoomed-in, exploded, cut-away, front perspective view of one embodiment of the present modular plant growing system, specifically illustrating a basic means for connection of one modular unit to another modular unit, where the hook on the lower unit passes through the open hook trough of the upper unit, and rests upon the hook connector of the upper unit.

FIG. 8 is an exploded, cut-away, front perspective view of one embodiment of the present modular plant growing system, specifically illustrating a basic means for connection of three modular units together, where the hook on the lower units passes through the open hook troughs of the upper units, and rests upon the hook connectors of the upper units.

FIG. 9 is an underneath perspective view of one embodiment of the present modular plant growing system, specifically illustrating one embodiment of the hook trough as a cross-width open trough.

FIG. 10 is an underneath perspective view of one embodiment of the present modular plant growing system, specifically illustrating one embodiment of the hook trough as a dual-slotted open trough, where the hook connector is visible from underneath.

FIG. 11 is an exploded, cut-away, front perspective view of one embodiment of the present modular plant growing system, specifically illustrating a basic means for connection of one modular unit to another modular unit, where the upper unit includes the addition of an insert tray, with integral drain holes and hook trough cover.

FIG. 12 is a zoomed-in, exploded, cut-away, front perspective view of one embodiment of the present modular plant growing system, specifically illustrating three modular units connected with insert tray, with integral drain holes.

FIG. 13 is a zoomed-in, exploded, cut-away, front perspective view of one embodiment of the present modular plant growing system, specifically illustrating a basic means for connection of one modular unit to another modular unit, where the upper unit includes the addition of an insert tray, with integral drain holes and hook trough cover.

FIG. 14 is a zoomed-in, exploded, cut-away, front perspective view of one embodiment of the present modular plant growing system, specifically illustrating one embodiment of an insert tray, with integral drain holes and hook trough cover.

FIG. 15 is a zoomed-in, exploded, cut-away, front perspective view of one embodiment of the present modular plant growing system, specifically illustrating one embodiment of an insert tray, with integral drain holes and hook trough cover.

FIG. 16 is an exploded, cut-away, front perspective view of one embodiment of the present modular plant growing system, specifically illustrating a basic means for connection of one modular unit to another modular unit, where the upper unit includes the addition of an insert tray, with integral hook connector, drain holes and hook trough cover.

FIG. 17 is an exploded, cut-away, front perspective view of one embodiment of the present modular plant growing system, specifically illustrating one embodiment of a water tight hook trough cover.

FIG. 18 is an exploded, cut-away, front perspective view of one embodiment of the present modular plant growing system, specifically illustrating one embodiment of a non-water tight hook trough cover.

FIG. 19 is a cut-away, front perspective view of two combined embodiments of the present modular plant growing system, specifically illustrating the combination of different form factors for the growing basin, in the form of a rectangular cross-section, and a circular cross-section, where the rectangular cross-sectional form factor calls for two hook troughs, two hook connectors each, and a level means of connection for said hooks for upper-most unit.

FIG. 20 is a zoomed-in, exploded, cut-away, front perspective view of one embodiment of the present modular plant growing system, specifically illustrating one embodiment of the hook connector as a separate part from the hook trough.

FIG. 21 is a zoomed-in, cut-away, front perspective view of one embodiment of the present modular plant growing system, specifically illustrating one embodiment of the hook connector as a separate part from the hook trough.

FIG. 22 is an exploded, cut-away, front perspective view of one embodiment of the present modular plant growing system, specifically illustrating step one of four total steps for the method of connection, where the hook of the lower unit is rotated slightly prior to inserting into the hook trough of the upper unit.

FIG. 23 is an exploded, cut-away, front perspective view of one embodiment of the present modular plant growing system, specifically illustrating step two of four total steps for the method of connection, where the hook of the lower unit is inserted up into the hook trough of the upper unit.

FIG. 24 is an exploded, cut-away, front perspective view of one embodiment of the present modular plant growing system, specifically illustrating step three of four total steps for the method of connection, where the hook of the lower unit is moved along the direction of the hook trough of the upper unit, ensuring that the hook of the lower unit passes over the hook connector of the upper unit.

FIG. 25 is an exploded, cut-away, front perspective view of one embodiment of the present modular plant growing system, specifically illustrating step four of four total steps for the method of connection, where the hook of the lower unit is rotated back to its natural vertical position, ensuring that the hook of the lower unit is resting upon the hook connector of the upper unit.

FIG. 26 is a front perspective view of one embodiment of the modular plant growing system, specifically, specifically illustrating an array of modular plant growing units.

FIG. 27 is an exploded, cut-away, front perspective view of one embodiment of the present modular plant growing system, specifically illustrating a basic variety of possible means for connection to the hook connector of one unit, specifically in the form of rope, a clip, or an s-hook.

FIG. 28 is a cut-away, front perspective view of one embodiment of the present modular plant growing system, specifically illustrating a basic variety of possible devices that could connect to the hook connector of the unit, specifically shown is an s-hook and a birdhouse.

FIG. 29 is a cut-away, front perspective view of one embodiment of the present modular plant growing system, specifically illustrating a basic variety of possible devices that could connect to the hook connector of the unit, specifically shown is an s-hook and wind chimes.

FIG. 30 is a cut-away, front perspective view of one embodiment of the present modular plant growing system, specifically illustrating a basic variety of possible devices that could connect to the hook connector of the unit, specifically shown is an s-hook and a bird feeder.

FIG. 31 is a cut-away, front perspective view of one embodiment of the present modular plant growing system, specifically illustrating a basic variety of possible devices that could connect to the hook connector of the unit, more specifically shown is an s-hook and a set of connecting tensile strings, or wire that could be used to train vines of growing plants.

FIG. 32 is a cut-away, front perspective view of one embodiment of the present modular plant growing system, specifically illustrating a basic variety of possible devices that could connect to the hook connector of the unit, more specifically shown is an s-hook and irrigation system tubing, or hose.

FIG. 33 is a cut-away, front perspective view of three combined embodiments of the present modular plant growing system, specifically illustrating the combination of different form factors for the growing basin, in the form of a rectangular cross-section, and a circular cross-section, where the rectangular cross-sectional form factor calls for two hook troughs, two hook connectors each, and a level means of connection for said hooks for upper-most unit. Additionally shown is the form providing a rotated hook to match level anchors protruding perpendicularly to the pot, and where the hook trough extends longitudinally along the length of the rectangular pot.

### DRAWING REFERENCE NUMERALS

Hook (10). Hanger (20). Growing Pot (30). Hook Trough (40). Hook Connector (50). Pot Insert (60). Hook Trough Cover (70). Miscellaneous Configurations and Accessories (80). Methodology (90).

### Detailed Description of the Invention

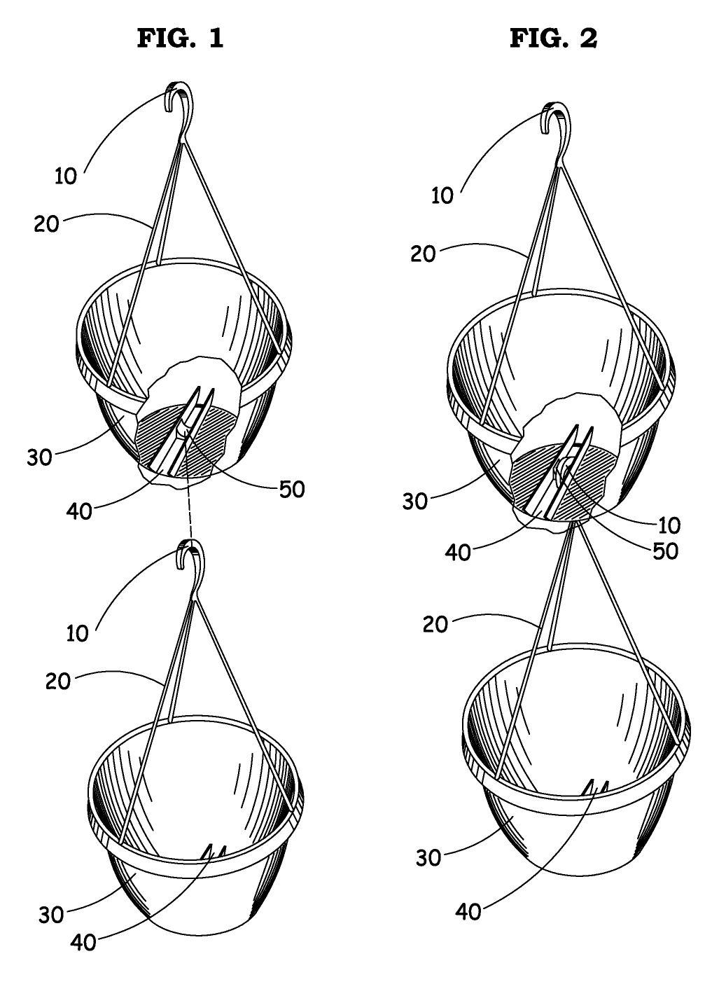

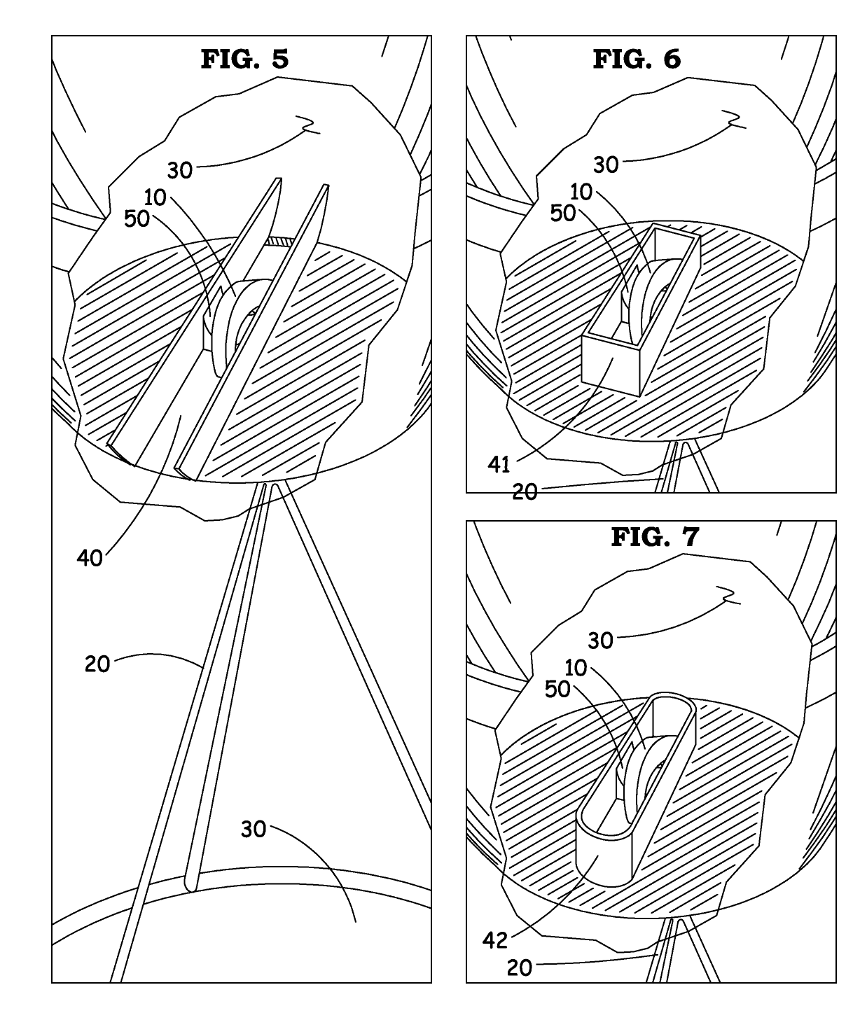

A first embodiment, preferred embodiment, and best mode, of the present modular plant growing system is shown in a front perspective, exploded, cut-away view in FIG. 1 and FIG. 2. FIG. 1 shows an exploded view, while FIG. 2 shows a condensed view. FIG. 5 illustrates a zoomed-in, cut-away view of FIG. 2. The modular plant growing system shown in this embodiment is comprised of a multitude of modular plant growing units, each of which is comprised of a hook 10, connected to the upper end of a hanger 20, which is connected at its lower end to a growing pot 30. The hanger 20 has means of connection to the hook 10 and the growing pot 30, which is well understood and often proprietary within the current industry. The specific means of the connection of these elements is not specifically claimed as a novel element of the present invention. The hanger is shown in these figures as a three-point system, but there are many other potential forms for this component, which are well developed for this industry, including, but not limited to, 4-point systems. A dual 2-point system is also developed in this disclosure for a polyhedral pot 31. The growing pot 30 has an integrated hook trough 40, which extends approximately central along the bottom surface of the growing pot 30. The hook trough 40 comprises an opening, with sidewalls and an open, or closed top, through the bottom surface of the growing pot 30 that allows access through the bottom surface of said growing pot 30 for the hook 10 of an adjacent modular plant growing unit from below. The hook trough 40 is connected to the bottom surface of the growing pot 30, and can be connected by various methodologies, including integral molding, injection-molding, glue, interference fitting, direct fastening, welding, or any other means used in current industrial manufacturing practices. The form of the hook trough 40 illustrated in FIG. 1, and FIG. 2, shows the hook trough 40 sidewalls extending across the entire length of the bottom surface of the growing pot 30, and connecting to the sidewalls of the growing pot 30. This is not necessary, as will be shown in the description of subsequent figures, yet this is the most efficient means to gain structural integrity of the growing pot 30, that is intended to distribute loading from connected modular units, and accessories, to the uppermost modular growing unit. The modular plant growing system further includes a hook connector 50, which is connected to the hook trough 40 through either permanent, or semi-permanent means. The hook trough 40 and hook connector 50 can be connected by various methodologies, including integral molding, injection-molding, glue, interference fitting, direct fastening, welding, or any other means used in current industrial manufacturing practices. The hook connector 50 semi-permanently engages to the hook 10 of said lower modular plant growing unit, through a specific methodology presented later in the disclosure. The intended purpose is to create an entirely modular growing system that will allow for a semi-permanent, strong and secure, yet easily removable connection between adjacently connected modular plant growing units, to create a complete system of growing units. The hook 10 of the uppermost modular plant growing unit is engaged to an anchoring location by means that are well understood and characterized by the hanging plant growing industry. These means can include bolts, screws, hooks, bars, wire, rope, or many other variations, which are not specifically claimed as novel to the present invention. The basic form of each of the elements described above is not of particular importance, in so much that they are designed to structurally support the intended loading. The basic descriptions of the elements above constitute the primary elements of the present invention, and will be referred to throughout the remainder of this section, as elements specifically included in other embodiments as noted.

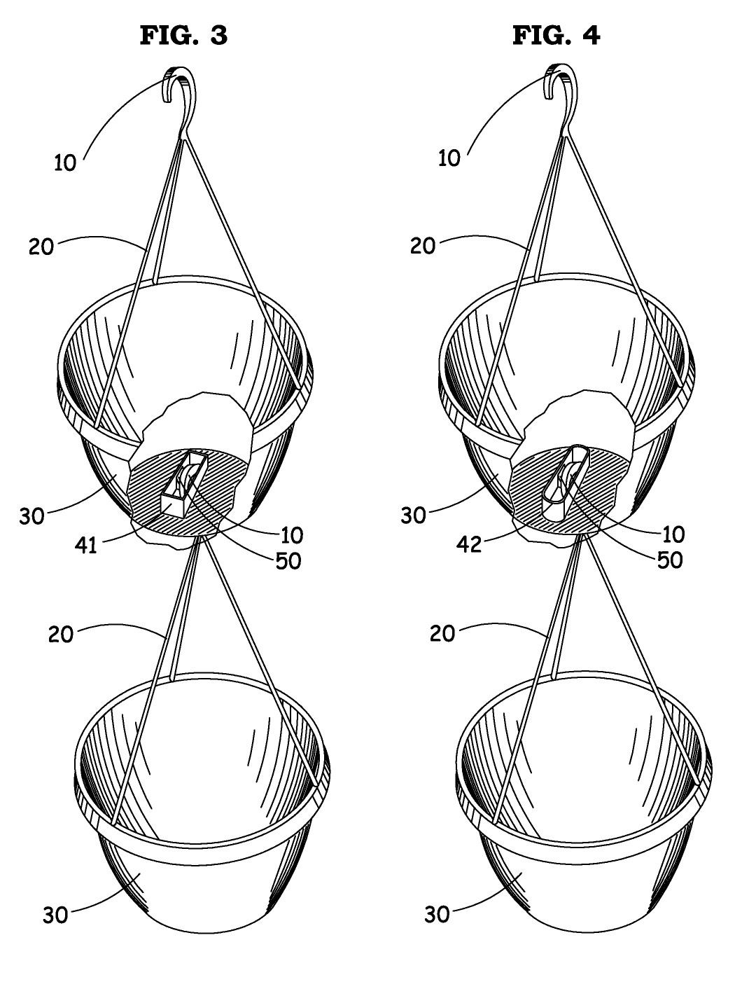

A second embodiment of the present modular plant growing system is shown in a front perspective, cut-away view in FIG. 3. FIG. 6 illustrates a zoomed-in, cut-away view of FIG. 3. The embodiment depicted in FIG. 3 differs from the embodiment shown in FIG. 1, and FIG. 2, in that the form of the hook trough 41 is shown as a polyhedron, and the sidewalls of the hook trough 41 do not extend to the sidewalls of the growing pot 30. This is particularly illustrated to show that the precise shape of the hook trough 41 is not important, so long as it is designed to support the structural loading of the overall system. All other elements and description from the discussion of the first embodiment remain the same.

A third embodiment of the present modular plant growing system is shown in a front perspective, cut-away view in FIG. 4. FIG. 7 illustrates a zoomed-in, cut-away view of FIG. 3. The embodiment depicted in FIG. 4 differs from the embodiment shown in FIG. 1, and FIG. 2, in that the form of the hook trough 42 is shown as a polyhedron with rounded end walls, and the sidewalls of the hook trough 42 do not extend to the sidewalls of the growing pot 30. This is particularly illustrated to show that the precise shape of the hook trough 42 is not important, so long as it is designed to support the structural loading of the overall system. All other elements and description from the discussion of the first embodiment remain the same.

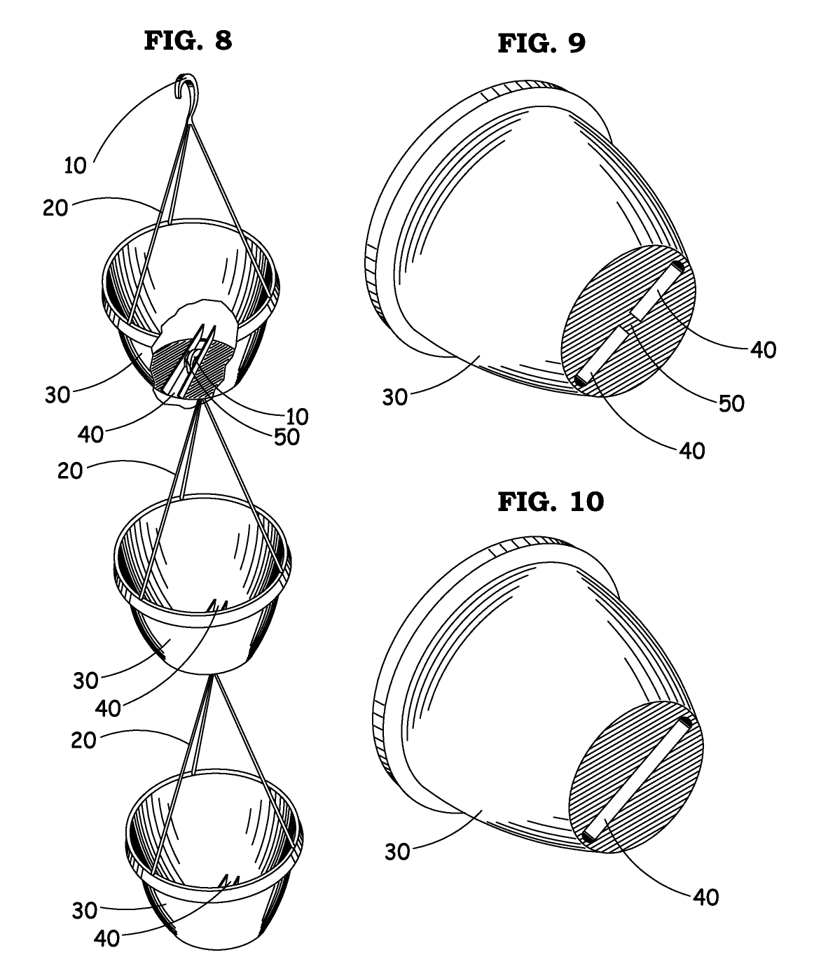

The present modular growing system is designed to allow a multitude of modular growing units to be connected into vertical-chains, as shown in FIG. 8, which shows a front perspective, cutaway view. The system illustrated in FIG. 8 shows an expansion of the discussion of the first embodiment above, but specifically shows the configuration of three modular growing units connected together into a vertical chain.

The hook trough 40, discussed in detail above, can take various forms. FIG. 9, and FIG. 10, provide an underneath perspective view of two separate embodiments of the present invention, respectively, more specifically showing the hook trough 40, and the hook connector 50. The primary purpose of these figures is to illustrate the general form of the hook trough 40, as viewed from underneath. It is clear that the hook trough 40, no matter the specific form, does not cause any issues with interference, usability, or create any unsightly features. The modular growing unit can be set directly on an approximately horizontal surface and remain in the upright position, which is the case for most growing pots currently on the market. Actually, most users will not notice the present invention, should the user decide to use the system in the conventional manner. So essentially, the functionality is hidden, and causes no deleterious effects as compared with existing technologies.

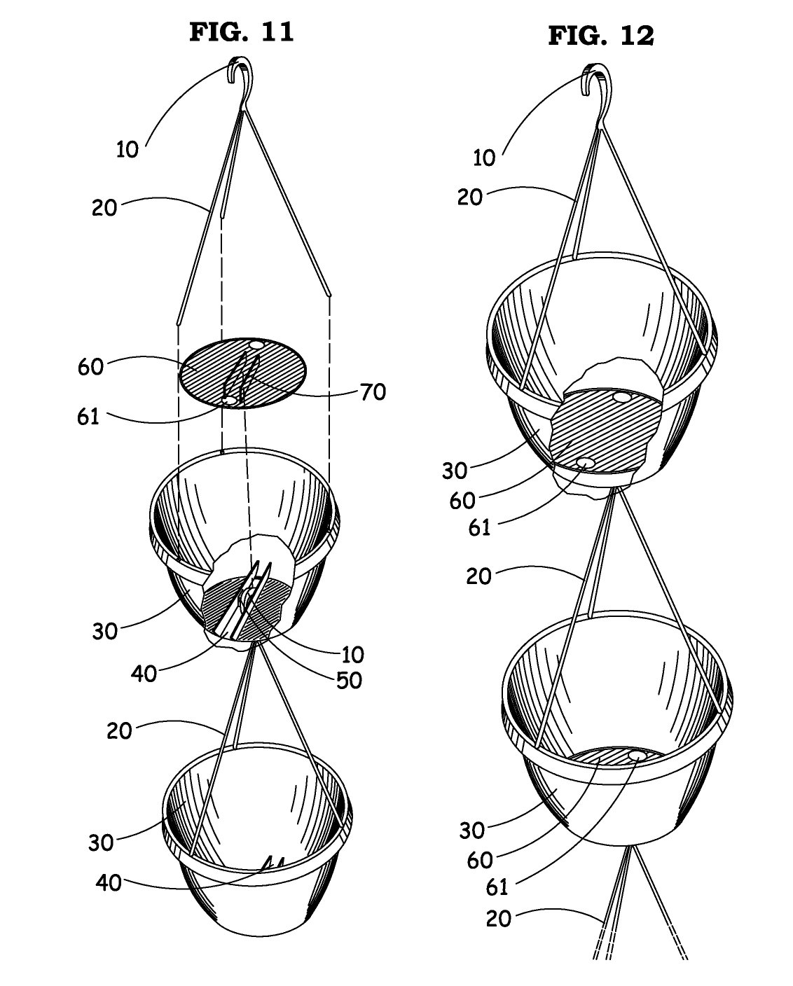

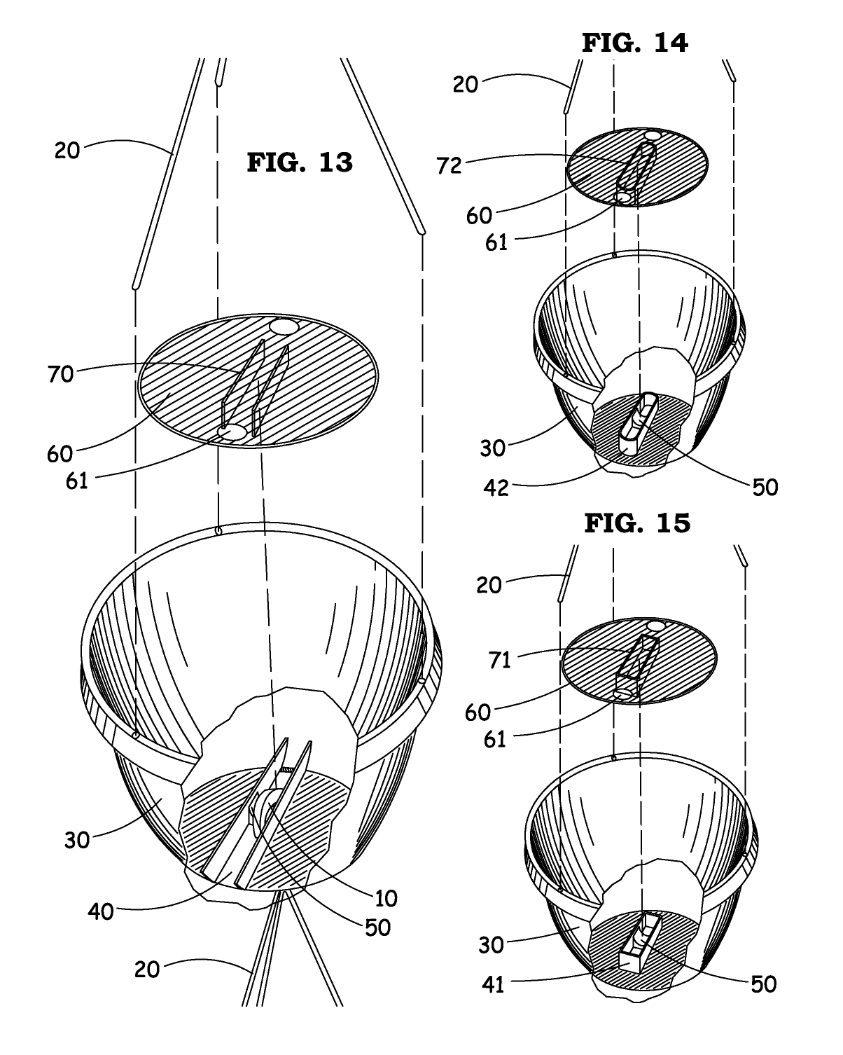

The present invention is designed to allow for the incorporation of the latest technologies for the plant and food growing industry, including hydroponics, and hydroculture. These fields specifically focus on the growing of plants using mineral nutrient solutions, specifically without the use of soil. Many innovations currently exist in the scope of the present invention that incorporate hydroponic elements. The present invention is capable of utilizing or incorporating these technologies without affecting the intended functions and benefits. The growing pot 30 itself is simply modified to include these features, or hydroponic inserts can be incorporated into the present invention. FIG. 11, and FIG. 12, illustrates an expansion to FIG. 1, and FIG. 2, respectively, specifically including a growing pot insert, hydroponic insert, or pot insert 60. The pot insert can serve various functions, and can be permeable, or impermeable, as required by the design. It is also possible to place pot insert drainage holes 61 at specific locations in the insert, if desired, specifically to control the location of drainage. The intention of these inserts is to ensure that hydroponic growing methods can be utilized, and to ensure that soils are adequately drained, as many plant species do not grow optimally when root systems are submersed. FIG. 11, and FIG. 12, also show a hook trough cover 70, which is designed to create a watertight seal over portions, or the entirety of, the hook trough 40, or to control drainage diversion location or locations. Water can either be directed through pot insert drain holes 61, or can be drained by other means utilized in the industry, such as drain holes in the lower surface of the growing pot 30. This is often accomplished through some form of plug, which can be integrated into the bottom surface, or can take the form of a hole with a separate plug. FIG. 13 provides a zoomed-in illustration of the configuration shown in FIG. 11. As can be visualized in FIG. 12, the features of the present invention are invisible to users, regardless of whether or not pot inserts 60, or hydroponic inserts, are utilized. The present invention does not negatively impact the intended functionality of pot inserts, but seamlessly integrates with them.

The particular form of the hook trough 40, is discussed in detail above, where FIG. 3, and FIG. 4, show potential variations for the form of the hook trough 40. Then FIG. 11, and FIG. 13, showed that a hook trough cover 70 could be integrated into a pot insert 60, which is also discussed in detail above. FIG. 14, and FIG. 15 show that the hook trough cover 71, and the hook trough cover 72, or any other form of hook trough cover, must match the specific requirements of the hook trough 41, and hook trough 42, respectively. Essentially, the hook trough cover 70 must approximately match the form of the hook trough 40.

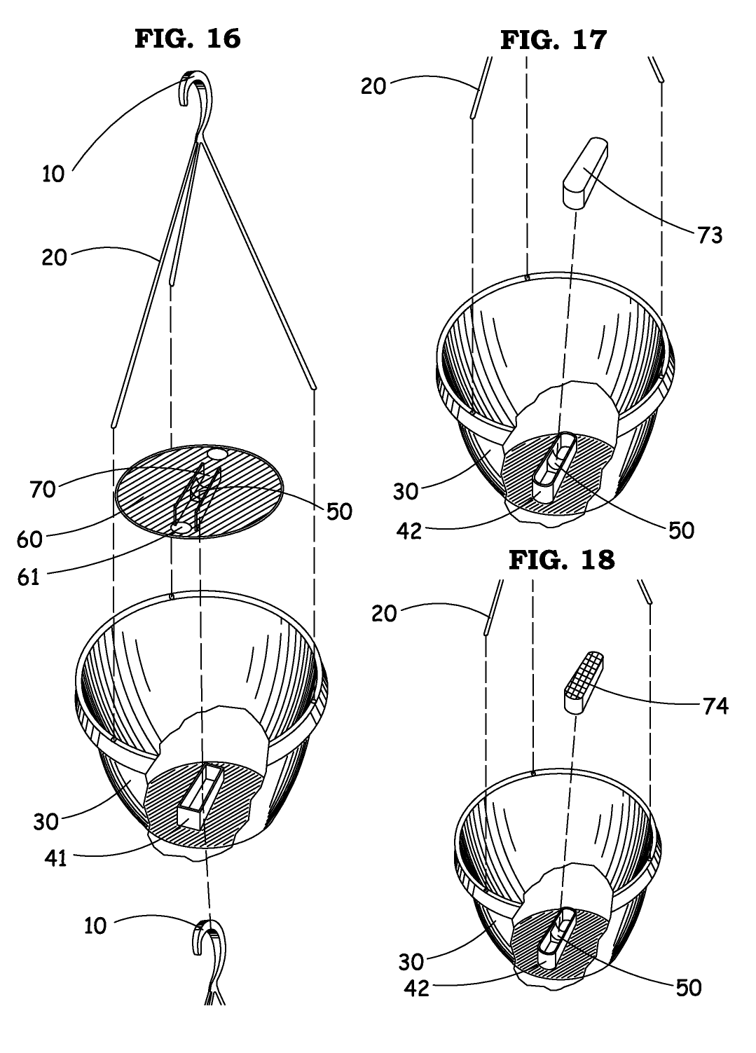

A fourth embodiment of the present invention is a variant of the previously described elements, where the hook connector 50 is not connected to the hook trough 40, but rather is connected to the pot insert 60 itself. The connection between the pot insert 60 and the hook trough 40 can be accomplished by various methodologies, including integral molding, injection-molding, glue, interference fitting, direct fastening, welding, or any other means used in current industrial manufacturing practices. FIG. 16 shows one potential embodiment of this alternative, where the hook connector 50 is connected to the hook trough cover 70, and the geometry matches with the hook trough 41 to create a watertight seal. It is important to note that this particular embodiment changes the load path through the modular growing unit. This embodiment causes the insert to be pulled down onto the top of the hook trough 40, providing a means for creating a positive watertight seal. This is an advantage to this embodiment.

The load path for a hanging series of two pots begins at the bottom-most growing pot 30, or accessory item 80. For this discussion, it is assumed that the pots have been structurally reinforced through well-understood design and manufacturing methods (ribs, gussets, baffle walls, or other structurally necessary enhancements). The loading due to the plant, soil, water content, and pot materials in the bottom pot is transmitted to the hull of the bottom growing pot 30 through multi-modal load sharing (shear, tension and compression). The hull of the growing pot 30 transmits the loads to the hanger 20, which then transmits the entire load of the lower growing pot 30 to the hook connector 50 of the upper growing pot 30. The hook connector 50 transmits the loads to the hook trough 40, then to the pot hull of the upper growing pot 30. This is a critical element of the design of this modular plant growing system. The upper growing pot 30 also must transmit the loading of its own contents to its hull. Therefore, the hull of the upper growing pot 30 must be capable of supporting greater than twice the loading as the lower growing pot 30 hull. The total loads are then transmitted in a similar manner to the uppermost growing pot 30 (through the hull, to the uppermost hanger 20, to the uppermost hook 10). The total load of the entire suspended planter system will be supported by the anchoring location. This is another critical element of the system design. The anchoring location for the system must be strong. Let it be noted that if there were three pots in a vertical series, the uppermost pot must be capable of supporting more than three times the loading of the lower pot. Various modes of failure must be analyzed by the manufacturer, including vibration, wind loading, buckling, fracture, deflection, and even slightly elastic, or plastic deformation.

The importance of the hook trough cover 70 has been discussed in detail above, but it must be made clear that the hook trough cover 70 itself is a separate element, that may, or may not, be used depending upon the desired functionality of the modular growing system. FIG. 17 specifically illustrates that an independent hook trough cover 73 may be utilized to create a watertight seal over the hook trough 42, as desired, without the use of the pot insert 60. FIG. 18 specifically illustrates that an independent hook trough cover 74 may be utilized to create a freely draining feature. Many currently existing products on the market incorporate a direct drainage feature as part of their product. This is more appropriate for outdoor hanging pots, rather than indoor, where drainage can be directed to the floor drains, or directly to the ground. Drainage in the present invention can be directed to modular growing units directly below other modular growing units, decreasing water usage and minimizing nutrient rich water loss.

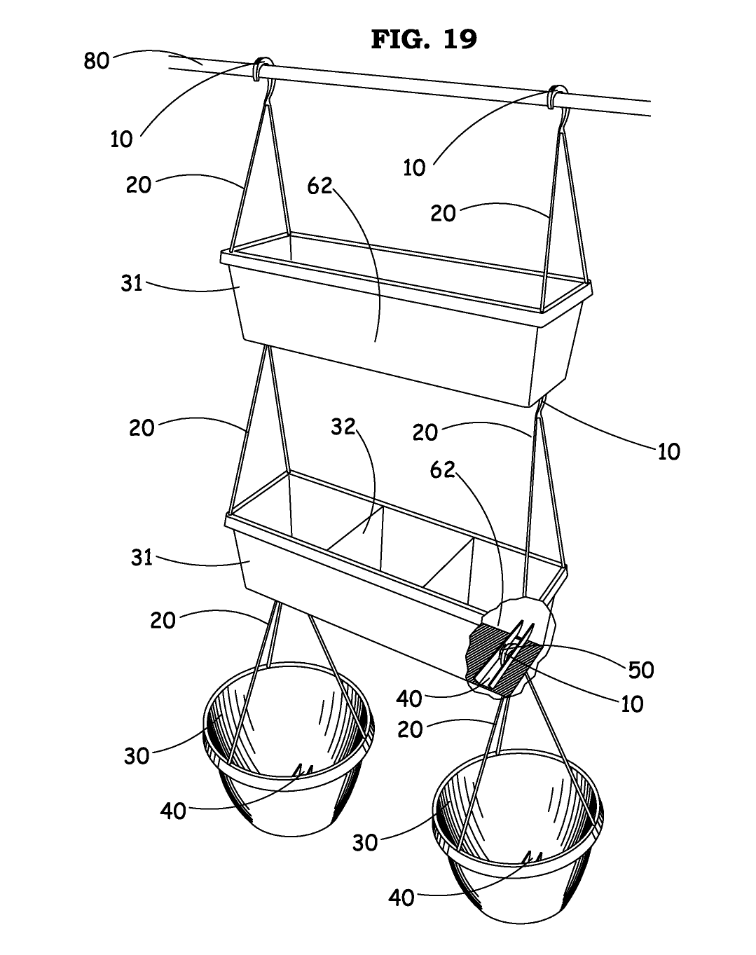

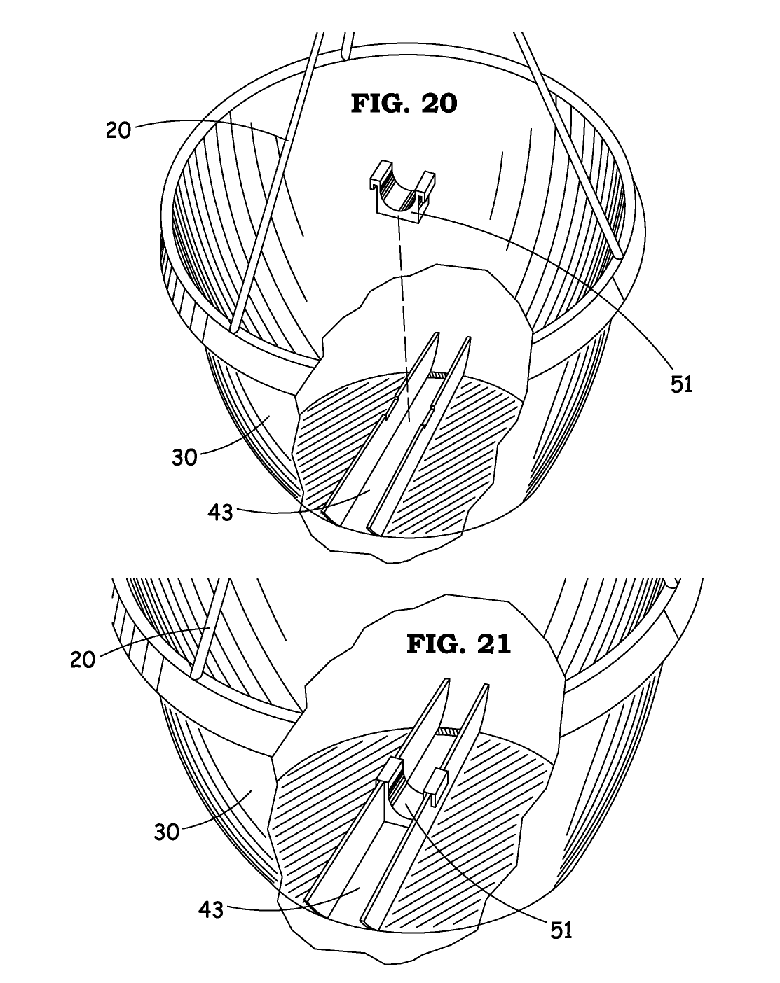

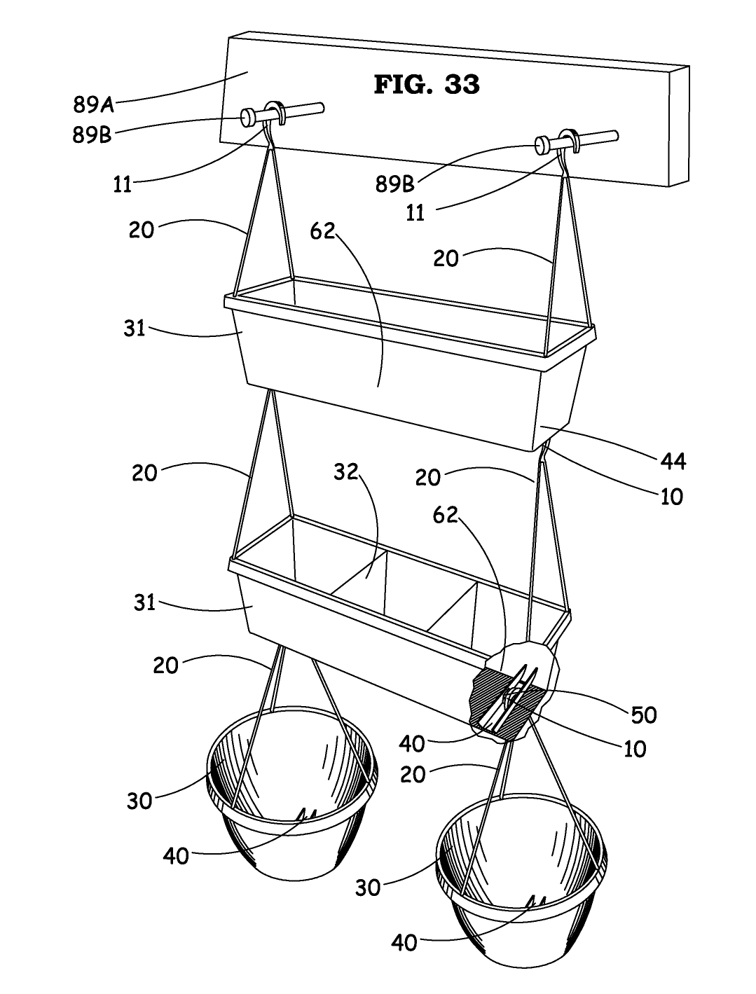

A fifth embodiment of the present invention is a dramatic diversion from present knowledge provided by the state-of-the-art. Most hanging pots today are of a round cross-sectional form factor for various reasons. The primary reason is that the symmetry of the form allows for uniform distribution of loading that will not warp the structure of the pot. Rectangular or polyhedral pots are very popular in the plant and food growing industry, and are well understood. This form factor has not been adapted to the hanging planter industry. The advantages of rectangular pots are discussed in detail above, but include a greater growing surface area and nutrient soil volume availability. Product yields and more directly visible decorative demonstrations can be shown in this form factor. The present invention has been developed to work with any form factor assuming the appropriate structural supporting elements are incorporated into the design. FIG. 19 provides a significant demonstration of the operational flexibility of use for the present invention, proving that the modular design is superior to existing technologies. A horizontal bar 80, or pipe, is utilized throughout the industry to create excellent locations to display hanging pots. By incorporating two hook troughs 40, and two hook connectors 50 into each polyhedral pot 31, it can be suspended by convention supporting structures, or a supporting structure can be easily constructed. This is a powerful capability that impacts the entire value chain of this industry, as is discussed in detail above. Due to the greater loading created by the larger volumes of these polyhedron pots 31 overhead support and structural design of the polyhedron pots 31 must be carefully designed. The design tools in this field are highly advanced, and well developed, but one means of structure support for the polyhedron pot 31 is shown in FIG. 19, as a transverse rib 32. The transverse rib 32 rigidifies the overall structure and prevents localized buckling of the polyhedral pot 31. This also creates distinct planting basins, which assists with growing diverse plant species without concerns about incompatibility and competition. It is very important to note that the previously developed technologies discussed in detail above, also can be adapted to the polyhedron pot 31. These features include all aspects of pot inserts 60, and hook trough covers 70. FIG. 19 shows the approximate location for the placement of pot inserts 62, although these are not shown in the figure for clarity. Round form factor pots 30 and polyhedral pots 31 can be combined in many possible configurations, which provides excellent growing, logistical, transport, preferential, retail, and decorative flexibilities. Finally, it is critically important to note, as is shown in FIG. 33, that considering the polyhedral growing pot 31 form, the hook 11 can be rotated 90 degrees in either direction to allow it to be connected to standard anchoring locations such as screws 89B. These screws would be inserted into the anchoring locations 89A at precisely level and spaced distances to match the configuration of the pot design. The preferred design for these hooks 11, the hanger 20 is designed to freely rotate 90 degree, or more. This allows the user to rotate the hook to connect to the desired anchoring location, which ensuring a level installation. This is accomplished simply through basic design and materials selection. Presently available materials are strong and flexible, which easily accommodates these requirements. This allows this configuration of pot to be suspended from nearly any location. In addition, the hook trough 44 can be oriented across the bottom surface of the growing pot 31, in any direction. This configuration would match the configuration of the rotated hook 11, mentioned immediately above. This form factor removes any barrier to entry or behavioral change requirements for common users, or even for commercial growers, depending upon their specific needs.

The functionality of the hook connector 50, and the hook trough 40 has been discussed detail above. The possibilities for connecting these elements in various configurations are also disclosed in detail. The form of the hook connector 50 is not particularly important as long as it is sufficiently strong, and allows free movement of the hook 10 through the hook trough 40, and over the hook connector 50. The hook connector can be made of almost any material and form that meets these conditions. It may also be noted that it is not particularly important what the hook connector 50 is connected to, as long as the above design criteria are also met. FIG. 20 shows one embodiment of the hook connector 51 as a separate element that is assembled to the hook trough 43 in a specific location. This particular embodiment of the hook connector 51 includes supporting side structures that rest over the structure of the hook trough 43 sidewalls when connected. The hook connector 51 is assembled with one of various potential methods such as integral molding, injection-molding, glue, interference fitting, direct fastening, welding, or any other means used in current industrial manufacturing practices. FIG. 21 illustrates the hook connector 51 connected to the hook trough 43 sidewalls.

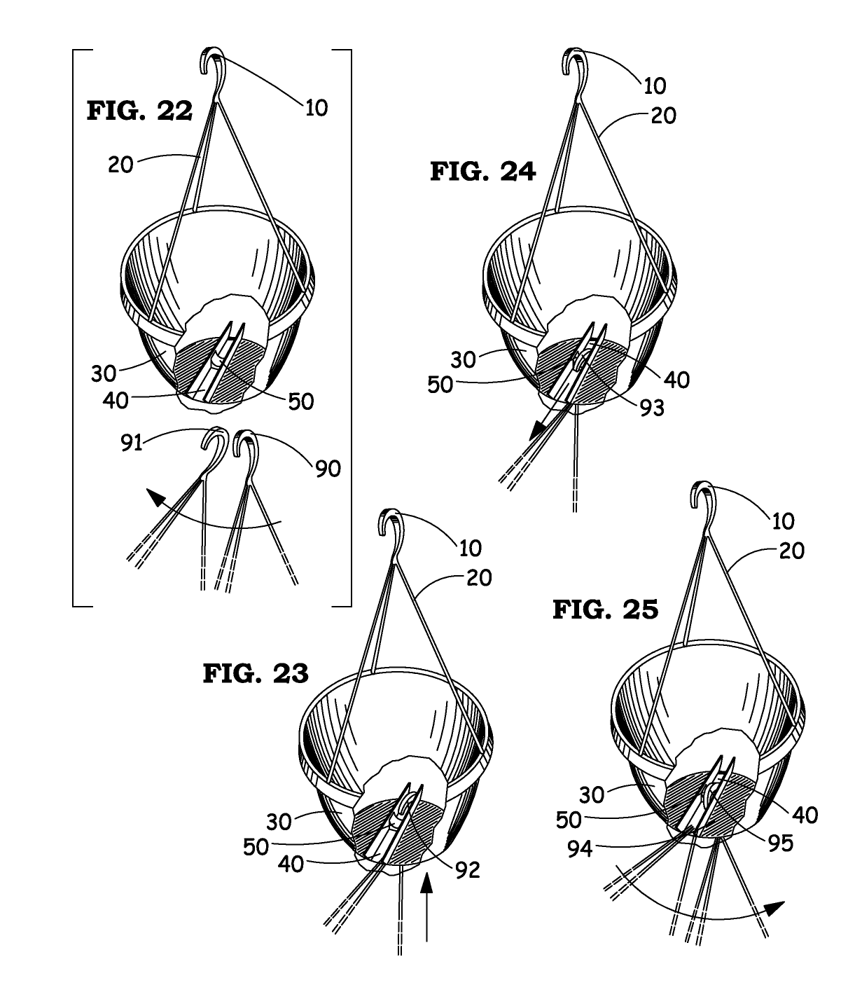

A critical requirement for the present invention is that it creates a means for secure, safe, temporary, and semi-permanent connection to adjacent modular growing units. It must also allow for quick and easy connect and disconnect of adjacent modular growing units. FIG. 22, FIG. 23, FIG. 24, and FIG. 25 provide a rudimentary disclosure of this methodology. Four total steps are required to connect on modular growing unit to another, and the process is simply reversed to disconnect on modular growing unit from another. These steps are described in detail as rudimentary action and motions, but in practice this method would be employed in one smooth, ergonomic motion. Step 1, as illustrated in FIG. 22, requires the user to support the growing pot 30, and rotate or bend the hanger 10 or hook 20, to align the end of the hook 10 with the hook trough 40. The natural position 90 and the rotate position 91 are illustrated, as well an arced arrow illustrating the general required motion. This is important for Step 3 as well, as will be seen. Step 2, as illustrated in FIG. 23, requires the user to lift the growing pot 30 until the hook 10 enters one end of the hook trough passing through the lower surface of the growing pot 30. The new position 92 after the required general motion is shown, as well an arrow illustrating the general required motion. Step 3, as illustrated in FIG. 24, requires the user to translate the hook along the hook trough 40, ensuring that the end of the hook 10 slides over the top of the hook connector 50. The new position 93 after the required general motion is shown, as well an arrow illustrating the general required motion. Step 4, as illustrated in FIG. 25, requires the user to rotate the hook 10 back to its natural position. The position prior to rotation 94 and the natural position 95 after rotation are shown, as well an arced arrow illustrating the general required motion. It is important to note that this method is the same for all embodiments of the present invention. It should also be noted that most hangers 20 in the market are constructed of either ductile metal or flexible plastic, so the rotation required by this method is well within the performance limits of the prescribed materials. It should also be noted that the length of the hanger 20 is not important to the functionality of the present invention, but can be important for the proper growth of a particular species of growing plant. The hanger 20 can easily be manufactured at various lengths to provide excellent operational and growing flexibility for growers. Utilizing shorter hangers also affects the overall bulk growing density of the hanging growing plant array. This functionality is assumed as an integral part of the present invention.

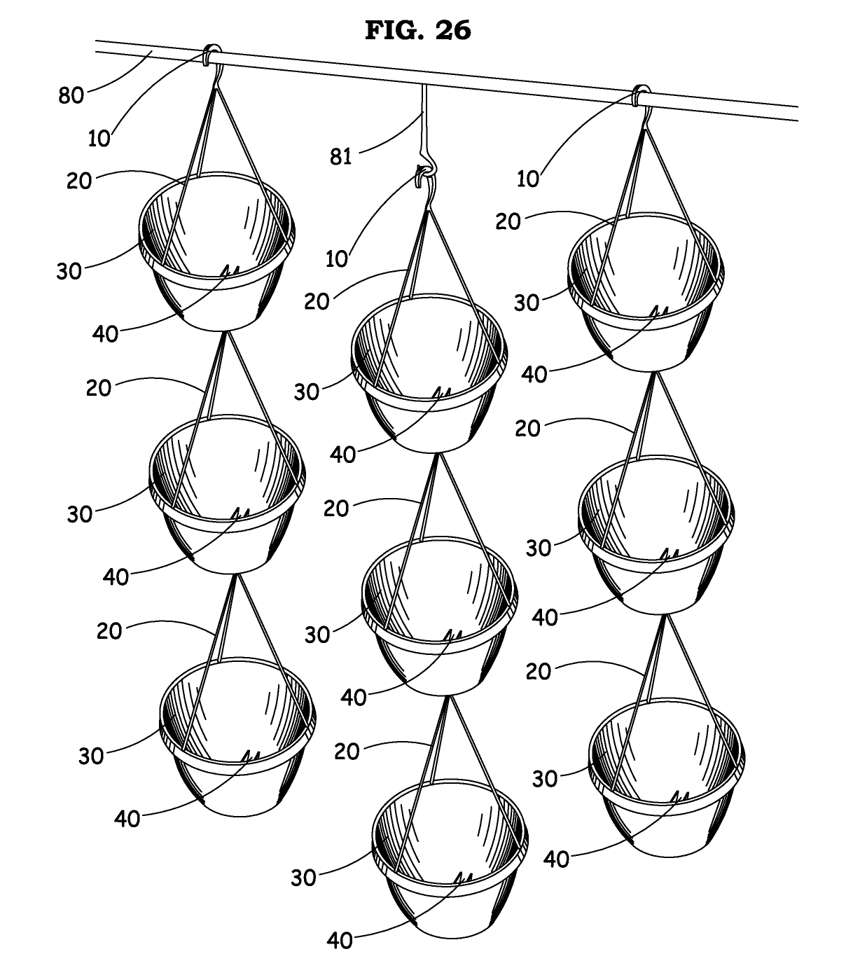

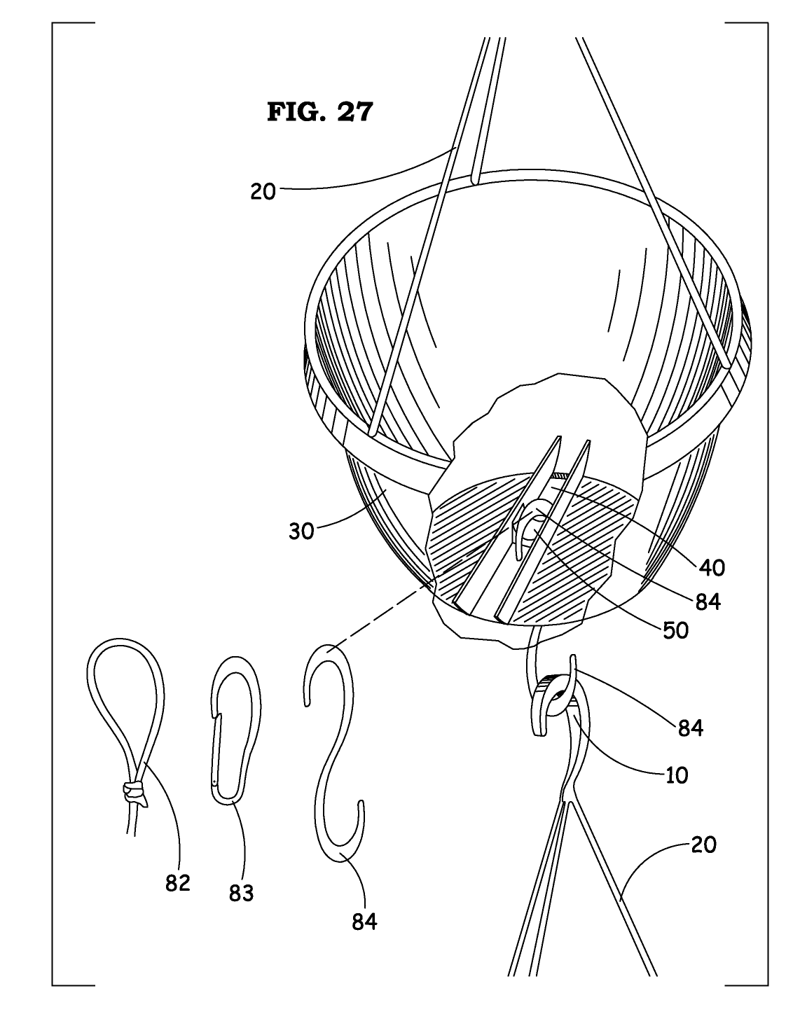

One of the primary benefits of the present invention is the significant level of efficiencies it creates for the entire value chain for this industry. These efficiencies include increased production capacities without new required capital infrastructure, enhanced operation flexibilities, reduction of space requirements, and many other benefits as discussed in detail above. FIG. 26 illustrates an array of modular growing units as a system. A bar 80, or a track system often used by large commercial growers, can be utilized to create this configuration. Vertical units are staggered with an extension hook 81 to ensure that light exposure and ventilation are maximized between vertical trains. It can be clearly seen that by using this configuration, it is possible to increase growing production unit volume by 200%, while using the same infrastructure, provided that the proper structural supporting requirements are met. It is important to note that these arrays can be built with any of the embodiments provided in this disclosure.

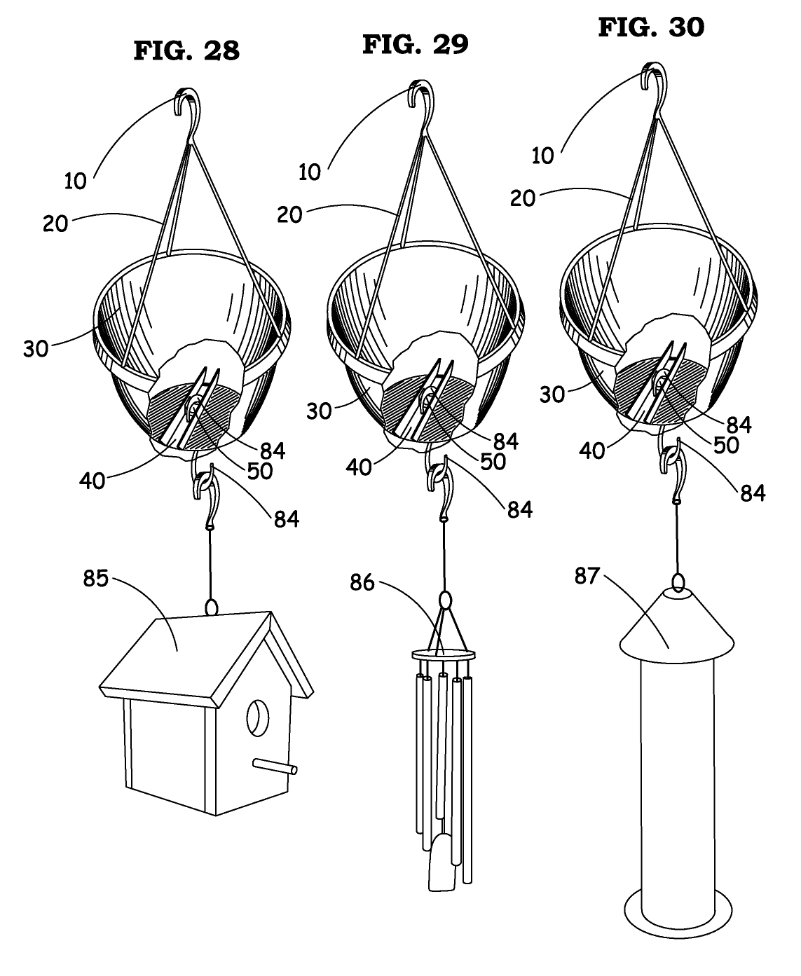

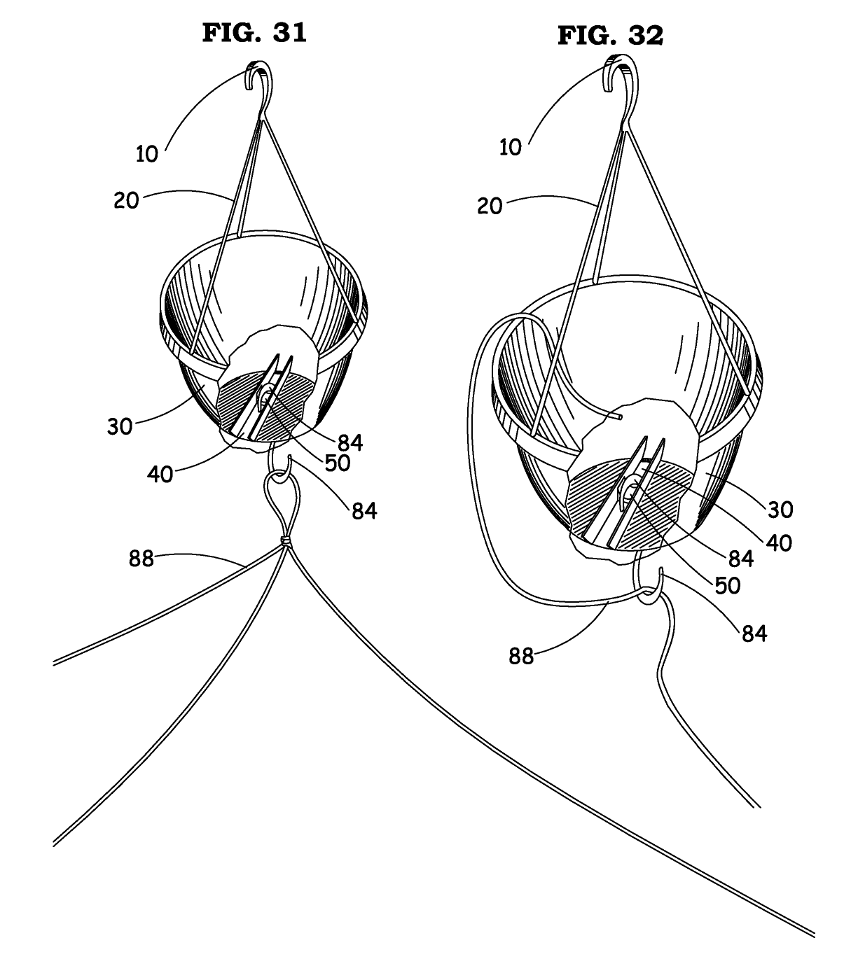

One advantage of the present invention is the universal nature of the modular growing unit connector. Thus far is this disclosure the topic of connecting modular growing units together had been the focus. An important benefit to the present invention is that the universal nature of the connector allows for the connection of nearly any related or unrelated product or items within practical limits of loading. FIG. 27 illustrates the flexibility of the universal connector by showing that nearly any hanging hardware can be used to connect other useful or decorative items. This hardware can include, but it not limited to, rope, s-hooks, wire, clips, or other means of connection. FIG. 27 specifically illustrates an s-hook 84, rope 82, and a fabricated clip 83. Many items can be connected for decorative or functional purposes, as illustrated in FIG. 28, FIG. 29, and FIG. 30, which show a bird house 85, wind chimes 86, and bird feeder 87, respectively, suspended from the hook connector 50, by utilizing an s-hook 84. FIG. 31 and FIG. 32, illustrate some options for useful items that can be connected to the present invention. FIG. 31 illustrates the connection of rope 88, or wire, connected to the modular growing system, which creates a useful means for growing plant vines, such as tomatoes, or flowering vines. This is accomplished by connecting an s-hook 84 to the hook connector 50, then connecting a multitude of ropes over the lower end of the s-hook 84, then anchoring the distal ends of the rope 88 to the any location. Plants are trained along the rope 88 lines as they grow, which is a common gardening practice. FIG. 32 illustrates a similar installation shown in FIG. 31, but the s-hook 84 is used to support an irrigation line up into the growing pot 30. Irrigation lines such as these are very useful, are commonly used in this industry, and often are comprised of drip-irrigation systems.

Although the above disclosure is rather specific, it is not considered to limit the scope of the invention, but only as a summary of the functionality of the preferred embodiments. Many variations of functionality and form are possible within the teachings of the invention. Therefore, the scope of the invention is determined by the appended claims and their legal equivalents, not by the limited examples provided.

The present invention has been described in detail specific to the preferred embodiments. The following claims allow for modifications and changes to the preferred embodiments of the present invention.

What is claimed is:

1. A modular plant growing system, comprising:
a. a hook having means for connecting to a general anchoring location;
b. a growing pot having side walls, an open top, and a bottom surface;
c. a hanger having means for connecting to the respective lower end of said hook, and having means for connecting to respective upper ends of said side walls of said growing pot;
d. a hook trough having a form general longer and slightly wider than said hook, having side walls, and means of connecting respective bottom ends of said side walls to said bottom surface of said growing pot, wherein the bottom surface of said growing pot between said sidewalls of said hook trough is devoid of material, which allows access from below to the inner space of said growing pot;
e. a hook connector having a general form capable of accepting and supporting said hook, and having means of connection to said sidewalls of said hook trough;
f. wherein said modular plant growing system is capable of supporting various items from said hook connector, including an additional modular plant growing system.

2. The modular plant growing system of claim 1, wherein said growing pot has the general form of a polyhedron, having two of said hook, two of said hanger, two of said hook trough, and two of said hook connector generally located on opposing sidewalls of said growing pot.

3. The modular plant growing system of claim 1, wherein a hook trough cover, having various potential forms and functions, and means of connection to said growing pot, and is inserted into said growing pot and rests approximately on the upper ends of said sidewalls of said hook trough.

4. The modular plant growing system of claim 2, wherein a hook trough cover, having various potential forms and functions, and means of connection to said growing pot, and is inserted into said growing pot and rests approximately on the upper ends of said sidewalls of said hook troughs.

5. The modular plant growing system of claim 3, wherein said hook trough cover is similar to common pot inserts, including hydroponic pot inserts, which may be permeable, or impermeable, as desired.

6. The modular plant growing system of claim 3, wherein said hook trough cover is a cap of similar form of said hook trough, which may be permeable, or impermeable, as desired.

7. The modular plant growing system of claim 4, wherein said hook trough cover is similar to common pot inserts, including hydroponic pot inserts, which may be permeable, or impermeable, as desired.

8. The modular plant growing system of claim 4, wherein said hook trough covers are caps of similar form of said hook troughs, which may be permeable, or impermeable, as desired.

9. The modular plant growing system of claim 5, wherein said hook trough cover is a cap of similar form of said hook trough, wherein said cap has means of connection to said pot insert.

10. The modular plant growing system of claim 7, wherein said hook trough covers are caps of similar form of said hook trough, wherein said caps have means of connection to said pot insert.

11. An modular plant growing system, comprising:
a. a hook having means for connecting to a general anchoring location;
b. a growing pot having side walls, an open top, and a bottom surface;
c. a hanger having means for connecting to the respective lower end of said hook, and having means for connecting to respective upper ends of said side walls of said growing pot;
d. a hook trough having a form general longer and slightly wider than said hook, having side walls, and means of connecting respective bottom ends of said side walls to said bottom surface of said growing pot, wherein the bottom surface of said growing pot between said sidewalls of said hook trough is devoid of material, which allows access from below to the inner space of said growing pot.

12. The modular plant growing system of claim 11, wherein a hook trough cover, having various potential forms and functions, and means of connection to said growing pot, and is inserted into said growing pot and rests approximately on the upper ends of said sidewalls of said hook troughs.

13. The modular plant growing system of claim 12, wherein said hook trough cover is similar to common pot inserts, including hydroponic pot inserts, which may be permeable, or impermeable, as desired.

14. The modular plant growing system of claim 12, wherein said hook trough cover is a cap of similar form of said hook trough, which may be permeable, or impermeable, as desired.

15. The modular plant growing system of claim 13, wherein said hook trough cover is a cap of similar form of said hook trough, wherein said cap has means of connection to said pot insert.

16. The modular plant growing system of claim 13, wherein a hook connector having a general form capable of accepting and supporting said hook, and having means of connection to said sidewalls of said hook trough, said modular plant growing system is capable of supporting various items from said hook connector, including an additional modular plant growing system.

17. The modular plant growing system of claim 14, wherein a hook connector having a general form capable of accepting and supporting said hook, and means for connection to said cap, wherein upon insertion of said cap, said hook connector extends into said hook trough, and said hook connector is capable of supporting various items designed to be suspended from said hook connector, including an additional modular plant growing system.

18. The modular plant growing system of claim 15, wherein a hook connector having a general form capable of accepting and supporting said hook, and means for connection to said cap, wherein upon insertion of said cap, said hook connector extends into said hook trough, and said hook connector is capable of supporting various items designed to be suspended from said hook connector, including an additional modular plant growing system.

19. A method for modular plant growing system assembly, disassembly, and use, comprising:
a. providing a modular plant growing system comprising a general anchoring location, a hook, growing pot, hanger, hook trough, and a hook connector, wherein one of said modular plant growing system is currently suspended from said general anchoring location;
i. said hook having means for connecting to a general anchoring location;
ii. said growing pot having side walls, an open top, and a bottom surface;
iii. said hanger having means for connecting to the respective lower end of said hook, and having means for connecting to respective upper ends of said side walls of said growing pot;
iv. said hook trough having a form general longer and slightly wider than said hook, having side walls, and means of connecting respective bottom ends of said side walls to said bottom surface of said growing pot, wherein the bottom surface of said growing pot between said sidewalls of said hook trough is devoid of material, which allows access from below to the inner space of said growing pot;
v. said hook connector having a general form capable of accepting and supporting said hook, and having means of connection to said sidewalls of said hook trough;
vi. wherein said modular plant growing system is capable of supporting various items from said hook connector, including an additional modular plant growing system.
vii. supporting said growing pot while rotating said hook or said hanger in order to align said hook to said hook trough;
viii. lifting said hook and said growing pot until said hook enters one end of said hook trough, passing through said lower surface of said growing pot;
ix. translating said hook along said hook trough until said hook passes over the top of said hook connector;
x. rotating said hook and said hanger back to its natural position, while reducing said support of said growing pot, transferring the weight of said modular plant growing system to said hook connector.
xi. disassembling said modular growing system is accomplished through reversal of the above method.

20. The method of claim 19, wherein said method for assembly and disassembly of said modular growing system is performed through the combination of all required motions as an integrated ergonomic motion.
